(19) United States
(12) Patent Application Publication
(10) Pub. No.: US 2016/0100212 A1
(43) Pub. Date: Apr. 7, 2016

(54) SAVING ADDRESSABLE COMMERCIALS TO PERSONAL VIDEO RECORDER

(71) Applicant: EchoStar Technologies L.L.C., Englewood, CO (US)

(72) Inventor: Shefali Modi, Castle Rock, CO (US)

(73) Assignee: EchoStar Technologies L.L.C.

(21) Appl. No.: 14/505,627

(22) Filed: Oct. 3, 2014

(51) Int. Cl. H04N 21/433; H04N 21/472; H04N 21/81; H04N 21/454; G11B 19/02; H04N 21/4147

(52) U.S. Cl. CPC H04N 21/4334; G11B 19/02; H04N 21/4147; H04N 21/812; H04N 21/454; H04N 21/472

(57) ABSTRACT

A media content processing system includes a memory device, and input port, and a processing device. The input port receives a media content signal that includes at least one addressable commercial content instance and at least one non-commercial content instance. The processing device is programmed to process the media content signal, record the addressable commercial content instance independent of the non-commercial content instance, and store the recorded addressable commercial content instance in the memory device.

### BACKGROUND

Personal video recorders allow users to digitally record live media content. Recorded media content is stored in the personal video recorder's memory. A graphical user interface allows the user to view a menu of recorded media content and select one of the instances of media content for playback.

### BRIEF DESCRIPTION OF THE DRAWINGS

FIG. 1 illustrates an example media content processing system that can record addressable commercial content instances independent of non-commercial content instances contained within a media content signal.

FIG. 2 is a flowchart of an example process for recording addressable commercial content instances during a live presentation of media content.

FIG. 3 is a flowchart of an example process for scheduling the recording of a future showing of addressable commercial content instances.

### DETAILED DESCRIPTION

Personal video recorders typically record content in blocks designated by a program guide. A block may represent an episode of a television show or a movie. Personal video recorders do not distinguish commercial content from non-commercial content. Therefore, a 30-minute block of an episode of a television show will include the television show (non-commercial content) and interspersed advertisements (commercial content). Therefore, personal video recorders leave no way to separate commercial content from non-commercial content.

Many businesses rely on addressable commercial content to advertise their products or services to consumers. Addressable commercial content may refer to commercial content that is targeted at particular television viewers, such as viewers in a particular geographic region. If the addressable commercial content includes promotional information like discount codes, the viewer must write down the promotional information quickly before it is forgotten. Attempting to record the addressable commercial on a personal video recorder may cause the user some frustration. Because personal video recorders record content in blocks, and because the personal video recorder cannot distinguish addressable commercial content from non-commercial content, the personal video recorder will record the current block, including both addressable commercial and non-commercial content, as opposed to just recording the addressable commercial content. It is up to the user to stop the recording at the appropriate time if the user only desires to record the addressable commercial content. Even then, personal video recorders list recorded content by the name of the non-commercial content presented in the program guide. Thus, the user will have to either remember what non-commercial content was playing when the addressable commercial content was recorded or go through each item in the list until the addressable commercial content is found. Furthermore, viewers are not typically given a schedule of when addressable commercial content will be shown in the future.

The system described below eliminates such issues. An example media content processing system that allows a user to manually record addressable commercials, or alternatively can automatically record addressable commercials, includes a memory device, an input port, and a processing device. The input port receives a media content signal. As discussed above, the media content signal includes addressable commercial content and non-commercial content. The processing device processes the media content signal, records the addressable commercial content instance independent of the non-commercial content instance, and stores the recorded addressable commercial content instance in the memory device.

The elements shown may take many different forms and include multiple and/or alternate components and facilities. The example components illustrated are not intended to be limiting. Indeed, additional or alternative components and/or implementations may be used.

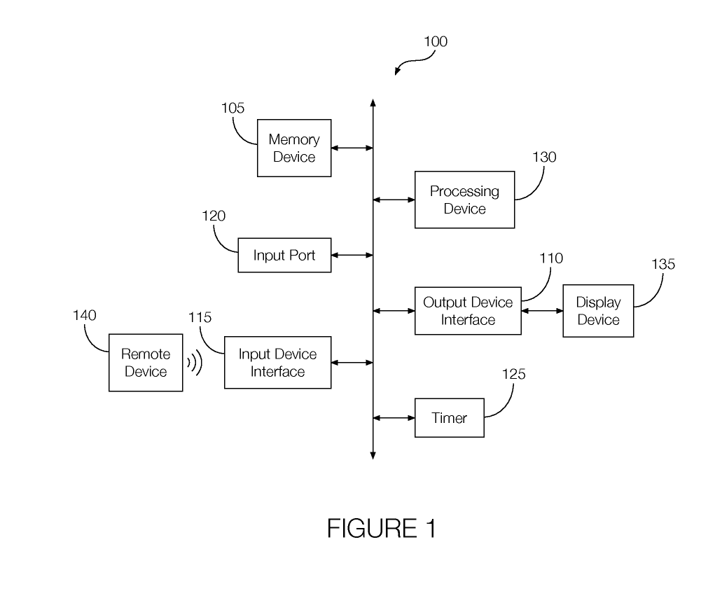

As illustrated in FIG. 1, an example media content processing system 100 includes a memory device 105, an output device interface 110, an input device interface 115, an input port 120, a timer 125, and a processing device 130.

The memory device 105 may be configured to store recorded media content, including addressable commercial and non-commercial media content. The memory device 105 may make recorded media content accessible to other components of the media content processing system 100 so that, e.g., the recorded content can be played back in response to a user input. In addition to storing recorded media content, the memory device 105 may be further configured to store data associated with the scheduling of media content. The schedules may include showing times associated with instances of addressable commercial content and non-commercial content.

The output device interface 110 may be configured to output signals to a display device 135, such as a television. The output device interface 110 may conform to any number of digital or analog audio or video protocols. For example, the output device interface 110 may include a high-definition multimedia interface (HDMI), an S-video interface, a composite video interface, a component video interface, a stereo audio interface, or the like. The output device interface 110 may output signals representing media content so that the media content may be displayed on the display device 135.

The input device interface 115 may be configured to receive signals representing a user input. The input device interface 115 may be in wireless communication with a remote device 140 such as a remote control. The input device interface 115 may be configured to comply with a wireless communication protocol such as an infrared communication standard, WiFi, Bluetooth®, etc. Examples of user inputs may include a command to turn on the display device 135, a command to turn on the media content processing system 100, a command to change a channel, a command to display a program guide, a command to display a list of recorded media content, a command to display a particular media content instance, or the like. Other user inputs may allow the user to navigate through a graphical user interface including, e.g., the program guide or the list of recorded media content and select a menu item or folder. The folders may be used to virtually organize media content. For instance, one folder may include addressable commercial content instances and another folder may include non-commercial content instances.

The input port 120 may be configured to receive a media content signal that includes live media content instances. The input port 120 may be configured to receive the media content signal either wirelessly or through, e.g., a coaxial cable or other type of wired connection.

The timer 125 may be programmed to output a signal at a predetermined time. The timer 125 may set the predetermined time based on a signal received from, e.g., the processing device 130, as discussed in greater detail below. The timer 125 may be programmed to mark the passage of time by, e.g., counting down to the predetermined time or by comparing a present time to the predetermined time. When the countdown reaches zero, or when the present time is equal to the predetermined time, the timer 125 may output the timer signal.

The processing device 130 may be programmed to process the media content signals received via the input port 120. For instance, the processing device 130 may include a decoder programmed to decode the media content signal. The output of the decoder may include signals representing media content instances. Therefore, the output of the decoder may be provided to the output device interface 110 so that, e.g., the media content can be presented, by the display device 135, to a user. Alternatively or in addition, the decoder may be programmed to store decoded media content in the memory device 105.

The processing device 130 may be further programmed to process signals received from the input device interface 115. In one possible approach, the processing device 130 may output commands in accordance with the user inputs received via the input device interface 115. Examples of commands may include a command to turn on the display device 135, a command to turn on the media content processing system 100, a command to change a channel, a command to display a program guide, a command to display a list of recorded media content, a command to display a particular media content instance, a command to output a signal at a particular time, or the like. The commands generated by the processing device 130 may be transmitted to, e.g., the output device interface 110, the input port 120, the timer 125, or the display device 135.

Moreover, the processing device 130 may be programmed to update a graphical user interface in response to user inputs. As discussed above, some user inputs may be associated with navigating a menu or selecting a menu item or folder. The processing device 130 may update the graphical user interface in accordance with the navigation inputs received as well as receive a user input representing a selection of a media content instance presented via the graphical user interface. In some instances, the processing device 130 may update the user graphical user interface to present an alert to a viewer that a particular addressable commercial content instance will be shown. The alert may further identify the type of promotion (e.g., discount code) that will be presented during the addressable commercial. In an alternative approach, the alert may be included in the media content signal and shown with the media content. Further, the graphical user interface may give the viewer the option to record the upcoming or possibly another showing of the addressable commercial content instance.

In addition to generating commands and receiving user inputs, the processing device 130 may be programmed to record a media content instance and store the recorded media content in the memory device 105. The processing device 130 may be further programmed to store addressable commercial content independent of non-commercial content in the memory device 105. Media content, including addressable commercial content, may be recorded in response to a user input. The user input commanding the media content processing system 100 to record a addressable commercial content instance may be received via the input device interface 115 and transmitted to the processing device 130. In response to receiving the user input, the processing device 130 may be programmed to record the addressable commercial content instance and store the addressable commercial content instance in the memory device 105.

The media content signal may include metadata associated with addressable commercial and non-commercial content instances. The metadata may include, e.g., the name of the media content instance, the length of the media content instance, the channel on which the media content instance was transmitted, etc. For addressable commercial content, the metadata may further or alternatively include promotional information such as coupon codes for products or services featured in the addressable commercial, information about the advertised product or service, information about when the addressable commercial will be shown again, information about the channels on which the addressable commercial will be shown, etc. The processing device 130 may be programmed to extract the metadata, and store the metadata in the memory device 105. In one possible approach, the metadata may be stored in a database that associates the metadata with the addressable commercial content instance. The database may further associate the addressable commercial content instance with one or more showing times. The processing device 130 may access the showing times from the schedule stored in the memory device 105. The showing times associated with each addressable commercial content instance may represent when the addressable commercial content instance will next be shown, as well as the channel on which the addressable commercial content instance will be shown.

The processing device 130 may receive a user input requesting that the addressable commercial content instance be recorded. If the addressable commercial content instance was recently shown, it may be accessible from the memory device 105. If not, the processing device 130 may be programmed to schedule a future recording of the addressable commercial content instance. To do so, the processing device 130 may determine the next showing time, where there are no scheduling conflicts, associated with the addressable commercial content instance from the database. The processing device 130 may output a signal to the timer 125 representing the showing time when the addressable commercial content instance will be recorded. When the processing device 130 receives the timer signal, the processing device 130 may record the addressable commercial content instance from the media content signal. The recorded addressable commercial content instance may be stored in one of the virtual folders in the memory device 105, and may be replayed in response to a user input selecting the addressable commercial content instance via the graphical user interface.

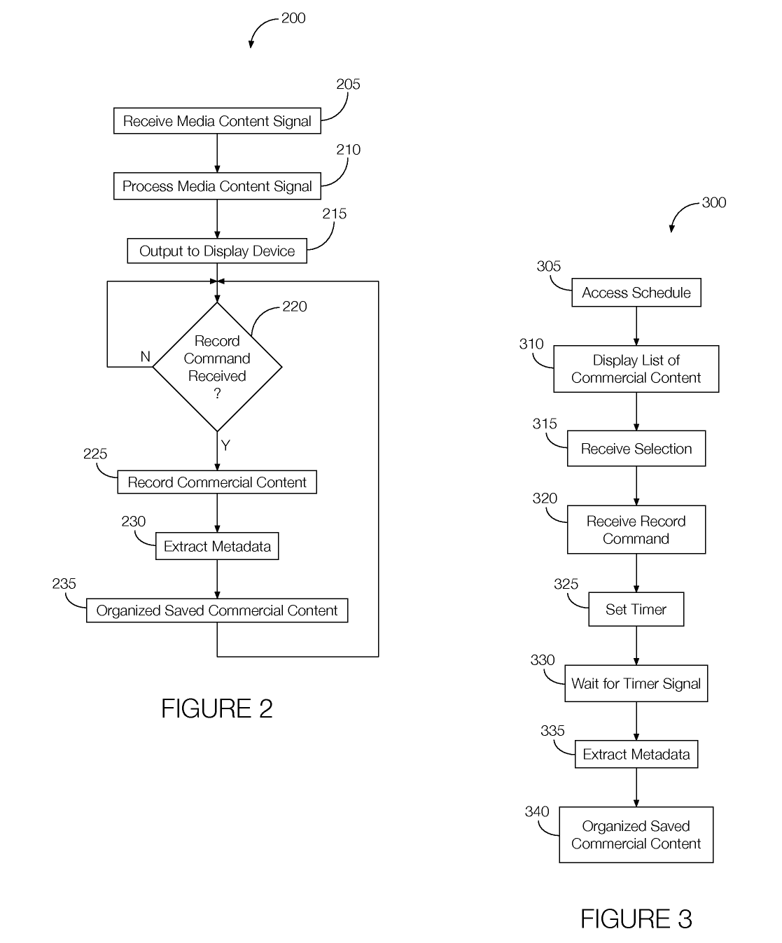

FIG. 2 is a flowchart of an example process 200, executed by the media content processing system 100, for recording addressable commercial content instances during a live presentation of media content.

At block 205, the media content processing system 100 may receive the media content signal. The media content signal, which may include addressable commercial and non-commercial content, may be received via the input port 120.

At block 210, the media content processing system 100 may process the media content signal. For example, the processing device 130 may identify instances of addressable commercial content and non-commercial content transmitted by the media content signal.

At block 215, the media content processing system 100 may output the media content to a display device 135. In one possible implementation, the processing device 130 may output the processed media content to the output device interface 110. The output device interface 110 may, via a wired connection, output the processed media content to the display device 135. Therefore, a user may view a live presentation of the addressable commercial or non-commercial content. The live presentation of the media content may include an alert indicating that a particular addressable commercial content instance will be shown in the near future (e.g., at the next commercial break). The alert may further identify the type of promotion (e.g., discount code) that will be presented to the viewer during the addressable commercial. Further, the graphical user interface may prompt the viewer the option to elect whether to record the upcoming addressable commercial content instance (see block 220) or possibly another showing of the addressable commercial content instance (see FIG. 3).

At decision block 220, the media content processing system 100 may determine whether a record command has been received. The record command may be transmitted from a remote device 140 operated by the user. The record command may be generated by the remote device 140 and wirelessly transmitted to the media content processing system 100 in response to a user input. The media content processing system 100 may receive the record command via the input device interface 115, and when received, the record command may command the media content processing system 100 to record addressable commercial content presently being shown on the display device 135. If the record command is received, the process 200 may continue at block 225. Otherwise, the process 200 may continually execute block 220 until the record command is received or until, e.g., the display device 135 or media content processing system 100 is turned off.

At block 225, the media content processing system 100 may record the addressable commercial content. To record the addressable commercial content, the processing device 130 may store the addressable commercial content in the memory device 105 independent of non-commercial content.

At block 230, the media content processing system 100 may extract the metadata associated with the recorded addressable commercial content. A database stored in the memory device 105 may be updated to include the extracted metadata. Moreover, the database may associate the extracted metadata with the recorded addressable commercial content instance.

At block 235, the media content processing system 100 may organize the saved addressable commercial content. For instance, the processing device 130 may associate the addressable commercial content with a virtual folder. The folder may be selected by a user by providing a user input to the graphical user interface. When the folder is selected, the contents of the folder may be presented to the user via the graphical user interface, which may further allow the user to select one of the media content instances saved in the folder. The selected content may be played on the display device 135. Alternatively or in addition, the metadata associated with the selected content may be displayed. Therefore, the user may view, e.g., promotional information such as coupon codes for products or services featured in the addressable commercial, information about the advertised product or service, information about when the addressable commercial will be shown again, information about the channels on which the addressable commercial will be shown, etc.

The process 200 may continue at block 220 until the media content processing system 100 or display device 135 is turned off.

FIG. 3 is a flowchart of an example process 300 for scheduling the recording of a future showing of addressable commercial content instances. As discussed above, the metadata associated with addressable commercial content may indicate when the addressable commercial content is to be shown again. Alternatively, showing times for the addressable commercial content instance may be determined from the alert transmitted with the media signal. The showing times of a particular addressable commercial content instance may be stored in the memory device 105 and used to schedule recordings of addressable commercial content. The process 300 may be initiated when a user provides a user input indicating a desire to record a particular addressable commercial content instance.

At block 305, the processing device 130 may access a schedule associated with the addressable commercial content instance from the memory device 105. The showing times for the addressable commercial content instance may have been transmitted in the metadata of a previous viewing of the addressable commercial content instance and stored in the memory device 105. Alternatively, the showing times may have been transmitted as part of the alert, discussed above.

At block 310, the processing device 130 may command the output device interface 110 to update the graphical user interface to show the list of selectable addressable commercial content instances or the schedule of showing times to the user. The graphical user interface may be presented to the user via the display device 135.

At block 315, the processing device 130 may receive a selection of one of the addressable commercial content instances, showing times, or both. The selection may be generated by a user input provided to the remote device 140. The remote device 140 may transmit a signal to the input device interface 115, and the processing device 130 may determine which addressable commercial content instance or showing time has been selected. For example, the user may use the remote device 140 to navigate through the graphical user interface. The user may provide a user input to select one of the addressable commercial content instances and another user input to select a particular showing time. If no showing time is selected, the processing device 130 may automatically select the next available showing time.

At block 320, the processing device 130 may receive a record command. The record command may be sent from the remote device 140 in response to a user input. The record command may be received at the input device interface 115 and transmitted to the processing device 130. The record command may, therefore, represent the user's desire to have the selected addressable commercial content recorded at the manually or automatically selected showing time.

At block 325, the processing device 130 may set the timer 125 to output the timer signal at the selected showing time. The timer 125 may be programmed to mark the passage of time by, e.g., counting down to the predetermined time or by comparing a present time to the predetermined time. When the countdown reaches zero, or when the present time is equal to the predetermined time, the timer 125 may output the timer signal.

At block 330, the processing device 130 may wait for the timer signal. When the timer signal is received, the processing device 130 may record the addressable commercial content. To record the addressable commercial content, the processing device 130 may store the addressable commercial content in the memory device 105 independent of non-commercial content.

At block 335, the processing device 130 may extract the metadata associated with the recorded addressable commercial content and store the extracted metadata in the database stored in the memory device 105. Moreover, the database may associate the extracted metadata with the recorded addressable commercial content instance.

At block 340, the processing device 130 may associate the recorded addressable commercial content with a virtual folder. The folder may be selected by a user by providing a user input to the graphical user interface. When the folder is selected, the contents of the folder may be presented to the user via the graphical user interface, which may further allow the user to select one of the media content instances saved in the folder. The selected content may be played on the display device 135. Alternatively or in addition, the metadata associated with the selected content may be displayed. Therefore, the user may view, e.g., promotional information such as coupon codes for products or services featured in the addressable commercial, information about the advertised product or service, information about when the addressable commercial will be shown again, information about the channels on which the addressable commercial will be shown, etc.

The process 300 may end after block 340 until, e.g., a user input is received that indicates a user's desire to record a particular addressable commercial content instance. As discussed above, such user input may initiate the process 300 to start from block 305.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, a set-top box, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A media content processing system comprising:
a memory device;
an input port configured to receive a media content signal including at least one addressable commercial content instance and at least one non-commercial content instance; and
a processing device programmed to process the media content signal, record the addressable commercial content instance independent of the non-commercial content instance, and store the recorded addressable commercial content instance in the memory device.

2. The media content processing system of claim 1, wherein the processing device is programmed to record the addressable commercial content instance in response to a user input.

3. The media content processing system of claim 2, wherein the user input includes a selection of the addressable commercial content instance.

4. The media content processing system of claim 1, wherein the processing device is programmed to extract metadata from the addressable commercial content instance.

5. The media content processing system of claim 1, wherein the memory device includes a schedule associating the addressable commercial content instances with at least one showing time.

6. The media content processing system of claim 5, wherein the processing device is programmed to record the addressable commercial content instance at one of the showing times.

7. The media content processing system of claim 5, wherein the processing device is programmed to determine the showing time from the schedule.

8. The media content processing system of claim 5, further comprising a timer programmed to output a timer signal, wherein the processing device is programmed to record the addressable commercial content instance in response to receiving the timer signal.

9. The media content processing system of claim 8, wherein the timer is programmed to output the timer signal in accordance with the showing time.

10. A method comprising:
receiving a media content signal including at least one addressable commercial content instance and at least one non-commercial content instance;
processing the media content signal to identify the addressable commercial content instance and the non-commercial content instance;
recording the addressable commercial content instance independent of the non-commercial content instance; and
storing the recorded addressable commercial content instance.

11. The method of claim 10, further comprising receiving a user input, wherein the addressable commercial content instance is recorded in response to the user input.

12. The method of claim 11, wherein the user input includes a selection of the addressable commercial content instance.

13. The method of claim 11, further comprising extracting metadata from the addressable commercial content instance.

14. The method of claim 11, further comprising accessing a schedule associating the addressable commercial content instances with at least one showing time.

15. The method of claim 14, wherein the addressable commercial content instance is recorded at one of the showing times.

16. The method of claim 14, further comprising determining the showing times from the schedule.

17. The method of claim 14, further comprising:
receiving a timer signal; and
wherein the addressable commercial content instance is recorded in response to receiving the timer signal.

18. A media content processing system comprising:
a memory device;
an input port configured to receive a media content signal including at least one addressable commercial content instance and at least one non-commercial content instance;
a processing device programmed to process the media content signal, record the addressable commercial content instance independent of the non-commercial content instance, and store the recorded addressable commercial content instance in the memory device;
an input device interface configured to receive a user input;
an output device interface configured to output the media content signal to a display device; and
a timer programmed to output a timer signal,
wherein the processing device is programmed to record the addressable commercial content instance in response to receiving the timer signal or the user input.

19. The media content processing system of claim 18, wherein the processing device is programmed to extract metadata from the addressable commercial content instance.

20. The media content processing system of claim 18, wherein the memory device includes a schedule associating the addressable commercial content instances with at least one showing time, and the timer is programmed to output the timer signal in accordance with at least one of the showing times.
